(19) United States
(12) Patent Application Publication
(10) Pub. No.: US 2005/0271212 A1
(43) Pub. Date: Dec. 8, 2005

(54) Sound source spatialization system

(75) Inventors: Eric Schaeffer, Le Bouscat (FR); Gerard Reynaud, Bordeaux (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/518,720

(22) PCT Filed: Jun. 27, 2003
(86) PCT No.: PCT/FR03/01998

§ 371 Date: Dec. 21, 2004

(30) Foreign Application Priority Data
Jul. 2, 2002 (FR) 02/08265

(51) Int. Cl. H04R 5/00; H04R 5/02

(52) U.S. Cl. 381/17; 381/309

(57) ABSTRACT

The present invention relates to an enhanced-performance sound source spatialization system used in particular to produce a spatialization system compatible with an integrated modular avionics type system. It comprises a filter database comprising a set of head-related transfer functions specific to the listener, a data presentation processor receiving information from each source and comprising in particular a module for computing the relative positions of the sources in relation to the listener and a module for selecting the head-related transfer functions with a variable resolution suited to the relative position of the source in relation to the listener, a unit for computing said monophonic channels by convoluting each sound source with head-related transfer functions of said database estimated at said source position.

The present invention relates- to an enhanced-performance sound source spatialization system used in particular to produce a spatialization system compatible with an Integrated Modular Avionics (IMA) type system.

In the field of onboard aeronautical equipment, most thoughts concerning the cockpit of the future are turned toward the need for a head-up headset display device, associated with a very large format head-down display. This assembly should improve situation awareness while reducing the burden of the pilot through a real-time summary display of information deriving from multiple sources (sensors, database).

3D sound falls into the same context as the headset display device by enabling the pilot to obtain spatial situation information (position of crew members, threats, etc.) within his own reference frame, via a communication channel other than visual by a natural method. As a general rule, 3D sound enhances the transmitted spatial situation information signal, whether the spatial situation is static or dynamic. Its use, besides locating other crew members or threats, can cover other applications such as multiple-speaker intelligibility.

In French patent application FR 2 744 871, the applicant described a sound source spatialization system producing for each source spatialized monophonic channels (left/right) designed to be received by a listener through a stereophonic headset, such that the sources are perceived by the listener as if they originated from a particular point in space, this point possibly being the actual position of the sound source or even an arbitrary position. The principle of sound spatialization is based on computing the convolution of the sound source to be spatialized (monophonic signal) with Head-Related Transfer Functions (HRTF) specific to the listener and measured in a prior recording phase. Thus, the system described in the abovementioned application comprises in particular, for each source to be spatialized, a binaural processor with two convolution channels, the purpose of which is on the one hand to compute by interpolation the head-related transfer functions (left/right) at the point at which the sound source will be placed, and on the other hand to create the spatialized signal on two channels from the original monophonic signal.

The object of the present invention is to define a spatialization system offering enhanced performance so that, in particular, it is suitable for incorporation in an integrated modular avionics (IMA) system which imposes constraints in particular on the number of processors and their type.

For this, the invention proposes a spatialization system in which it is no longer necessary to perform a head-related transfer function interpolation computation. It is then possible, to carry out the convolution operations for creating the spatialized signals, to have no more than a single computer instead of the n binaural processors needed in the system according to the prior art for spatializing n sources.

More specifically, the invention relates to a spatialization system for at least one sound source creating for each source two spatialized monophonic channels designed to be received by a listener, comprising:
a filter database comprising a set of head-related transfer functions specific to the listener,
a data presentation processor receiving the information from each source and comprising in particular a module for computing the relative positions of the sources in relation to the listener,
a unit for computing said monophonic channels by convolution of each sound source with head-related transfer functions of said database estimated at said source position,
   the system being characterized in that said data presentation processor comprises a head-related transfer function selection module with a variable resolution suited to the relative position of the source in relation to the listener.

The use of the databases of transfer functions related to the head of the pilot adjusted to the accuracy required for a given information item to be spatialized (threat, position of a drone, etc.), allied with optimal use of the spatial information contained in each of the positions of these databases considerably reduces the number of operations to be carried out for spatialization without in any way degrading performance.

Other advantages and features will become more clearly apparent on reading the description that follows, illustrated by the appended drawings which represent:

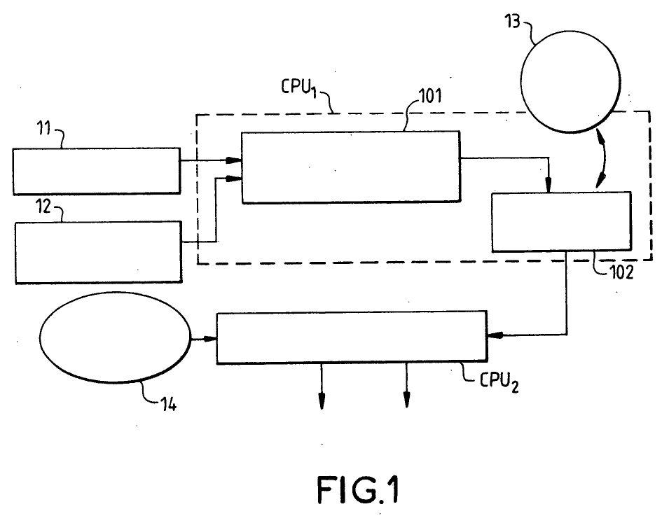

FIG. 1, a general diagram of a spatialization system according to the invention;

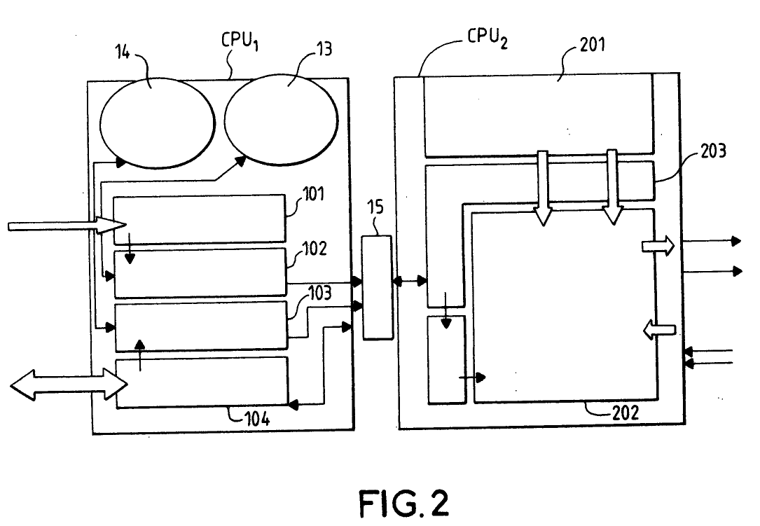

FIG. 2, a functional diagram of an embodiment of the system according to the invention;

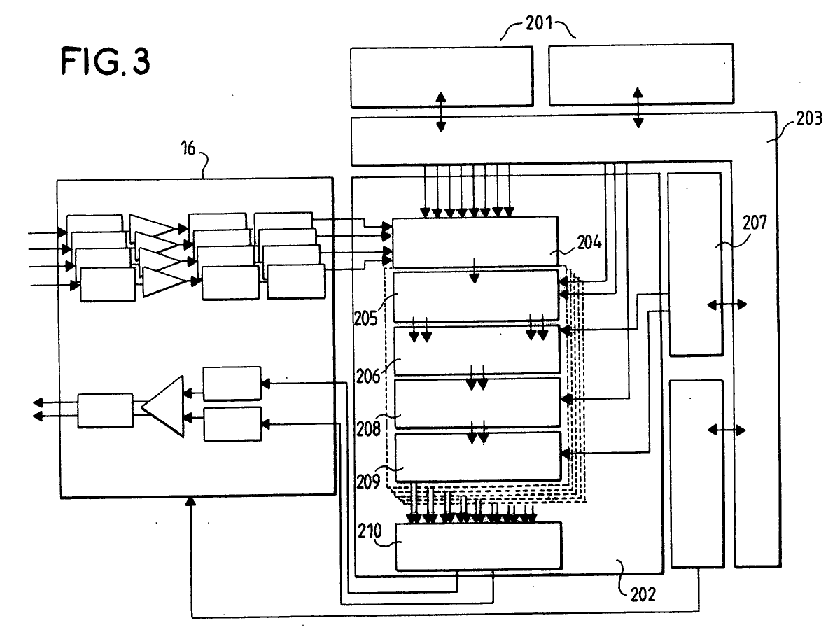

FIG. 3, the diagram of a computation unit of a spatialization system according to the example in FIG. 2;

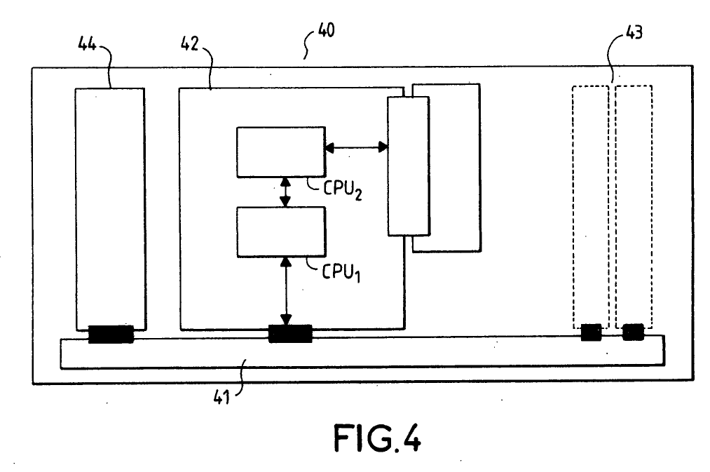

FIG. 4, a diagram of implantation of the system according to the invention in an IMA type modular avionics system.

The invention is described below with reference to an aircraft audiophonic system, in particular for a combat aircraft, but it is clearly understood that it is not limited to such an application and that it can be implemented equally in other types of vehicles (land or sea) and in fixed installations. The user of this system is, in the present case, the pilot of an aircraft, but there can be a number of users thereof simultaneously, particularly in the case of a civilian transport airplane, devices specific to each user then being provided in sufficient numbers.

FIG. 1 is a general diagram of a sound source spatialization system according to the invention, the purpose of which is to enable a listener to hear sound signals (tones, speech, alarms, etc.) using a stereophonic headset, such that they are perceived by the listener as if they originated from a particular point in space, this point possibly being the actual position of the sound source or even an arbitrary position. For example, the detection of a missile by a counter-measure device might generate a sound, the origin of which seems to be the source of the attack, enabling the pilot to react more quickly. These sounds (monophonic sound signals) are for example recorded in digital form in a “sound” database. Moreover, the changing position of the sound source according to the pilot's head movements and the movements of the airplane is taken into account. Thus, an alarm generated at “3 o'clock” should be located at “12 o'clock” if the pilot turns his head 90° to the right.

The system according to the invention mainly comprises a data presentation processor CPU1 and a computation unit CPU2 generating the spatialized monophonic channels. The data presentation processor CPU1 comprises in particular a module 101 for computing the relative positions of the sources in relation to the listener, in other words within the reference frame of the listener's head. These positions are, for example, computed from information received by a detector 11 sensing the attitude of the listener's head and by a module 12 for determining the position of the source to be restored (this module possibly comprising an inertial unit, a location device such as a direction finder, a radar, etc.). The processor CPU1 is linked to a “filter” database 13 comprising a set of head-related transfer functions (HRTF) specific to the listener. The head-related transfer functions are, for example, acquired in a prior learning phase. They are specific to the listener's inter-aural delay (the delay with which the sound arrives between his two ears) and the physionomical characteristics of each listener. It is these transfer functions that give the listener the sensation of spatialization. The computation unit CPU2 generates the spatialized L and R monophonic channels by convoluting each monophonic sound signal characteristic of the source to be spatialized and contained in the “sound” database 14 with head-related transfer functions from said database 13 estimated at the position of the source within the reference frame of the head.

In the spatialization systems according to the prior art, the computation unit comprises as many processors as there are sound sources to be spatialized. In practice, in these systems, a spatial interpolation of the head-related transfer functions is necessary in order to know the transfer functions at the point at which the source will be placed. This architecture entails multiplying the number of processors in the computation unit, which is inconsistent with a modular spatialization system for incorporation in an integrated modular avionics system.

The spatialization system according to the invention has a specific algorithmic architecture which in particular enables the number of processors in the computation unit to be reduced. The applicant has shown that the computation unit CPU2 can then be produced using an EPLD (Embedded Programmable Logic Device) type programmable component. To do this, the data presentation processor of the system according to the invention comprises a module 102 for selecting the head-related transfer functions with a variable resolution suited to the relative position of the source in relation to the listener (or position of the source within the reference frame of the head). With this selection module, it is no longer necessary to perform interpolation computations to estimate the transfer functions at the position where the sound source should be located. This means that the architecture of the computation unit, an embodiment of which is described below, can be considerably simplified. Moreover, since the selection module selects the resolution of the transfer functions according to the relative position of the sound source in relation to the listener, it is possible to work with a database 13 of the head-related transfer functions comprising a large number of functions distributed evenly throughout the space, bearing in mind that only some of these will be selected to perform the convolution computations. Thus, the applicant worked with a database in which the transfer functions are collected at 7° intervals in azimuth, from 0 to 360°, and at 10° intervals in elevation, from −70° to +90°.

Moreover, the applicant has shown that with the resolution selection module 102 of the system according to the invention, the number of coefficients of each head-related transfer function used can be limited to 40 (compared to 128 or 256 in most systems of the prior art) without degrading the sound spatialization results, which further reduces the computation power needed by the spatialization function.

The applicant has therefore demonstrated that the use of the databases of head-related transfer functions of the pilot adjusted to the accuracy required for a given information item to be spatialized, allied with optimal use of the spatial information contained in each of the positions of these bases can considerably reduce the number of operations to be performed for spatialization without in any way degrading performance.

The computation unit CPU2 can thus be reduced to an EPLD type component, for example, even when a number of sources have to be spatialized, which means that the dialog protocols between the different binaural processors needed to process the spatialization of a number of sound sources in the systems of the prior art can be dispensed with.

This optimization of the computing power in the system according to the invention also means that other functions which will be described below can be introduced.

FIG. 2 is a functional diagram of an embodiment of the system according to the invention.

The spatialization system comprises a data presentation processor CPU1 receiving the information from each source and a unit CPU2 for computing the spatialized right and left monophonic channels. The processor CPU1 comprises in particular the module 101 for computing the relative position of a sound source within the reference frame of the head of the listener, this module receiving in real time information on the attitude of the head (position of the listener) and on the position of the source to be restored, as was described previously. According to the invention, the module 102 for selecting the resolution of the transfer functions HRTF contained in the database 13 is used to select, for each source to be spatialized, according to the relative position of the source, the transfer functions that will be used to generate the spatialized sounds. In the example of FIG. 2, a sound selection module 103 linked to the sound database 14 is used to select the monophonic signal from the database that will be sent to the computation unit CPU2 to be convoluted with the appropriate left and right head-related transfer functions. Advantageously, the sound selection module 103 prioritizes between the sound sources to be spatialized. Based on system events and platform management logic choices, concomitant sounds to be spatialized will be selected. All of the information used to define this spatial presentation priority logic passes over the high speed bus of the IMA. The sound selection module 103 is, for example, linked to a configuration and programming module 104 in which customization criteria specific to the listener are stored.

The data regarding the choice of head-related transfer functions HRTF and the sounds to be spatialized is sent to the computation unit CPU2 via a communication link 15. It is stored temporarily in a filtering and digital sound memory 201. The part of the memory containing the digital sounds called “earcons” (name given to sounds used as alarms or alerts and having a highly meaningful value) is, for example, loaded on initialization. It contains the samples of audio signals previously digitized in the sound database 14. At the request of the host CPU1, the spatialization of one or several of these signals will be activated or suspended. While activation persists, the signal concerned is read in a loop. The convolution computations are performed by a computer 202, for example an EPLD type component which generates the spatialized sounds as has already been described.

In the example of FIG. 2, a processor interface 203 forms a memory used for the filtering operations. It is made up of buffer registers for the sounds, the HRTF filters, and coefficients used for other functions such as soft switching and the simulation of atmospheric absorption which will be described later.

With the spatialization system according to the invention, two types of sounds can be spatialized: earcons (or sound alarms) or sounds directly from radios (UHF/VHF) called “live sounds” in FIG. 2.

FIG. 3 is a diagram of a computation unit of a spatialization system according to the example of FIG. 2.

Advantageously, the spatialization system according to the invention comprises an input/output audio conditioning module 16 which retrieves at the output the spatialized left and right monophonic channels to format them before sending them to the listener. Optionally, if “live” communications have to be spatialized, these communications are formatted by the conditioning module so they can be spatialized by the computer 202 of the computation unit. By default, a sound originating from a live source will always take priority over the sounds to be spatialized.

The processor interface 203 appears again, forming a short term memory for all the parameters used.

The computer 202 is the core of the computation unit. In the example of FIG. 3, it comprises a source activation and selection module 204, performing the mixing function between the live inputs and the earcon sounds.

With the system according to the invention, the computer 202 can perform the computation functions for the n sources to be spatialized. In the example of FIG. 3, four sound sources can be spatialized.

It comprises a dual spatialization module 205, which receives the appropriate transfer functions and performs the convolution with the monophonic signal to be spatialized. This convolution is performed in the temporal space using the offset capabilities of the Finite Impulse Response (FIR) filters associated with the inter-aural delays.

Advantageously, it comprises a soft switching module 206, linked to a computation programming register 207 optimizing the choice of transition parameters according to the speed of movement of the source and of the head of the listener. The soft switching module provides a transition, with no audible switching noise, on switching from one pair of filters to the next. This function is implemented by a dual linear weighting ramp. It involves double convolution: each sample of each output channel results from the weighted sum of two samples, each being obtained by convoluting the input signal with a spatialization filter, an element from the HRTF database. At a given instant, there are therefore in input memory two pairs of spatialization filters for each track to be processed.

Advantageously, it comprises an atmospheric absorption simulation module 208. This function is, for example, provided by a 30-coefficient linear filtering and single-gain stage, implemented on each channel (left, right) of each track, after spatialization processing. This function enables the listener to perceive the depth effect needed for his/her operational decision-making.

Finally, dynamic weighting and summation modules 209 and 210 respectively are provided to obtain the weighted sum of the channels of each track to provide a single stereophonic signal compatible with the output dynamic range. The only constraint associated with this stereophonic reproduction is associated with the bandwidth needed for sound spatialization (typically 20 kHz).

FIG. 4 diagrammatically represents the hardware architecture of an integrated modular avionics system 40 of IMA type. It comprises a high speed bus 41 to which all the functions of the system, including in particular the sound spatialization system according to the invention 42, as described previously, the other man/machine interface functions 43 such as, for example, voice control, head-up symbology management, headset display, etc., and a system management board 44 the function of which is to provide the interface with the other aircraft systems, are connected. The sound spatialization system 42 according to the invention is connected to the high speed bus via the data presentation processor CPU1. It also comprises the computation unit CPU2, as described previously and for example comprising an EPLD component, compatible with the technical requirements of the IMA (number and type of operations, memory space, audio sample encoding, digital bit rate).

1. A spatialization system for at least one sound source creating for each source two spatialized monophonic channels (L, R) designed to be received by a listener, comprising:
a filter database comprising a set of head-related transfer functions specific to the listener,
a data presentation processor receiving the information from each source and comprising in particular a module for computing the relative positions of the sources in relation to the listener,
a unit for computing said monophonic channels by convolution of each sound source with head-related transfer functions of said database estimated at said source position,
wherein said data presentation processor comprises a head-related transfer function selection module with a variable resolution suited to the relative position of the source in relation to the listener.

2. The spatialization system as claimed in claim 1, wherein the head-related transfer functions included in the database are collected at 7° intervals in azimuth, from 0 to 360°, and at 10° intervals in elevation, from −70° to +90°.

3. The spatialization system as claimed in claim 1, wherein the number of coefficients of each head-related transfer function is approximately 40.

4. The spatialization system as claimed in claim 1, wherein it comprising a sound database including in digital form a monophonic sound signal characteristic of each source to be spatialized, this sound signal being designed to be convoluted with the selected head-related transfer functions.

5. The sound spatialization system as claimed in claim 4, wherein the data presentation processor comprises a sound selection module linked to the sound database prioritizing between the concomitant sound sources to be spatialized.

6. The sound spatialization system as claimed in claim 5, wherein the data presentation processor comprises a configuration and programming module to which is linked the sound selection module and in which are stored customization criteria specific to the listener.

7. The spatialization system as claimed in claim 1, wherein it comprises an input/output audio conditioning module which retrieves at the output the spatialized monophonic channels to format them before sending them to the listener.

8. The spatialization system as claimed in claim 7, wherein since live communications have to be spatialized, these communications are formatted by the conditioning module so they can be spatialized by the computation unit.

9. The sound spatialization system as claimed in claim 1, wherein the computation unit comprises a processor interface linked with the data presentation unit and a computer for generating spatialized monophonic channels.

10. The sound spatialization system as claimed in claim 9, wherein since the system comprises a sound database, the processor interface comprises buffer registers for the transfer functions from the filter database and the sounds from the sound database.

11. The spatialization system as claimed in claim 9, wherein the computer is implemented by an EPLD type programmable component.

12. The spatialization system as claimed in claim 10, wherein the computer comprises a source activation and selection module, performing the mixing function between live communications and the sounds from the sound database.

13. The spatialization system as claimed in claim 9, wherein the computer comprises a dual spatialization module which receives the appropriate transfer functions and performs the convolution with the monophonic signal to be spatialized.

14. The spatialization system as claimed in claim 9, wherein the computer comprises a soft switching module implemented by a dual linear weighting ramp.

15. The spatialization system as claimed in claim 9, wherein the computer comprises an atmospheric absorption simulation module.

16. The spatialization system as claimed in claim 9, wherein the computer comprises a dynamic range weighting module and a summation module to obtain the weighted sum of the channels of each track and provide a single stereophonic signal compatible with the output dynamic range.

17. An integrated modular avionics system comprising a high speed bus to which is connected the sound spatialization system as claimed in claim 1 via the data presentation processor.

18. The spatialization system as claimed in claim 11, wherein the computer comprises a source activation and selection module, performing the mixing function between live communications and the sounds from the sound database.

19. The spatialization system as claimed in claim 10, wherein the computer comprises a dual spatialization module which receives the appropriate transfer functions and performs the convolution with the monophonic signal to be spatialized.

20. The spatialization system as claimed in claim 10, wherein the computer comprises an atmospheric absorption simulation module.
